(19) United States
(12) Patent Application Publication
(10) Pub. No.: US 2026/0285723 A1
(43) Pub. Date: Sep. 24, 2026

(54) DESALINATION AND SOFTENING OF PRODUCED WATER

(71) Applicant: Chevron U.S.A. Inc., San Ramon, CA (US)

(72) Inventors: Prakhar PRAKASH, San Ramon, CA (US); Madhu IYENGAR, San Ramon, CA (US); Preston FERNANDES, San Ramon, CA (US); Jack HAN, San Ramon, CA (US)

(21) Appl. No.: 19/167,912

(22) PCT Filed: Mar. 23, 2023
(86) PCT No.: PCT/US2023/016033

§ 371 Date: Sep. 23, 2025

(51) Int. Cl. C02F 5/00; C02F 101/32; C02F 103/08

(52) U.S. Cl. CPC C02F 5/00; C02F 2101/32; C02F 2103/08; C02F 2209/06

(57) ABSTRACT

The present disclosure advantageously refers to a process for treating produced water to make suitable for a flooding or other application. The process comprises deoiling a produced water to form a substantially deoiled produced water. The deoiled produced water may be passed through a microfiltration membrane comprising an ion-exchange functionality. In this manner water may be treated to, for example, comprise a total dissolved solids content of less than about 30,000 ppm or less and a hardness of, for example, less than about 400 ppm. The processes may be readily modified to treat water to one or more desired characteristics which are flexible, efficient, cost-effective, and/or be sufficiently modifiable to fit for purpose a water treatment.

### CROSS REFERENCE TO RELATED APPLICATION(S)

This is a national stage application filed under 37 U.S.C. 371 based on International Patent Application NO. PCT/US2023/016033, filed Mar. 23, 2023, the disclosure of which is incorporated herein by reference in its entirety.

### FIELD OF THE DISCLOSURE

The present disclosure relates to desalination and softening of produced water for use in, for example, cyclic steam injection, steam flooding, and/or polymer flooding.

### BACKGROUND AND SUMMARY

Heavy Oilfields are often developed over time and initial phase of development often involves cyclic steam injection steps where steam injection is carried out in a designated production zone of the field to produce oil. Once a job is completed, any water treatment facility may be moved to another part of the oilfield which in some cases may be 5 to 6 kilometers or more. Challenges may be experienced due to the water quality along with the desire to have a portable facility that may be transported from one location to another. Once the field matures, the enhanced oil recovery mode may switch to a continuous steam flood. More volumes are treated in a continuous manner and the rigor of treatment may tend to go up as the equipment integrity and performance often should be maintained in-situ which presents one or more potential issues.

First, water used to produce steam is often high temperature (140-170 F) and conventional reverse osmosis membranes may not withstand these temperature conditions as in some cases they are only suitable for use up to 105-110 F. Thus, unfortunately, feed water (produced water) may need to be cooled to make it suited for a reverse osmosis process. And then any treated desalinated water is usually heated again for steam generation. This introduced inefficiencies in many processes.

Additionally, the production water may have a high concentration of acid gas such as H₂S (300-800 ppm) and/or CO₂ (50-200 ppm). The presence of one or both gases may degenerate reverse osmosis membranes. Accordingly, an alternative technology may be desirable.

Second, high hardness in water can cause severe demand for water softening salts, acid and base, resulting in challenges with chemicals management. If so, large volumes of chemicals may need to be transported which leads to additional challenges and increased cost. Sometimes, the total salinity of the water (TDS=Total Dissolved Solids) may be much higher (15,000-30,000 ppm) than desired which makes traditional processes less effective. This also may compromise the quality of any softened water generated for an application like steam flood. Accordingly, there is a need to reduce the TDS to a manageable range (<10,000 ppm in some cases) to make a process effective

Third, equipment and treatment processes may become very expensive if thermal desalination such as mechanical vapor compression (MVC) is employed. Unfortunately, the units are not very modular and are not very mobile. As an example, a 1500 bspd unit may utilize a footprint of 100 feet by 100 feet which often makes moving such a unit a challenge. Moreover, if thermal desalination is employed, then it is typically energy intensive and may contribute to greenhouse gas emissions.

Lastly, existing processes often excessively treat feedwater. That is, some applications, e.g., feedwater for a once through steam generator (OTSG) at 80% steam quality may only need a TDS of <30,000. However, typical processes may be very energy intensive and have other deficiencies as described above to produce a very low salinity water (<150 ppm for RO and <20 ppm for thermal) which is an over treatment. Accordingly, processes are needed which may be readily modified to treat water to one or more desired characteristics which are flexible, efficient, cost-effective, and/or be sufficiently modifiable to fit for purpose a water treatment.

Advantageously, the processes described herein may overcome one or more up to all of the deficiencies described above. The present application generally pertains to a process for treating produced water. The process comprises deoiling a produced water to form a substantially deoiled produced water. The deoiled produced water is passed through a microfiltration membrane comprising an ion-exchange functionality under conditions sufficient to produce a water suitable for a steam flooding application. The water suitable for a flooding or other application may comprise a total dissolved solids content of less than about 30,000 ppm and a hardness of less than about 400 ppm.

In another embodiment, the present application pertains to a process for treating produced water comprising deoiling a produced water to form a substantially deoiled produced water. The deoiled produced water is passed through a microfiltration membrane comprising an ion-exchange functionality under conditions sufficient to produce a water suitable for a steam flooding application. The water suitable for a flooding application may comprises a total dissolved solids content of less than about 30,000 ppm and a hardness of less than about 400 ppm. The deoiling may comprises a combination of employing corrugated plate interceptors and induced gas floatation. The microfiltration membrane may comprise an ion-exchange functionality which comprises a membrane comprising a polyvinylidene difluoride, a polyacrylonitrile, or a combination thereof. The membrane comprises an ion-exchange functionality comprising a sulfonic acid functional group, a carboxylic acid functional group, or a combination thereof.

These and other features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Various embodiments of the present disclosure, together with further objects and advantages, may best be understood by reference to the following description taken in conjunction with the accompanying drawings.

FIG. 1 shows a process of partial desalination and softening using hybrid ion exchange pore functionalized microfiltration (MF) and electrodialysis reversal (EDR).

FIG. 2 shows a process of partial desalination and softening using cation site ion exchange pore functionalized microfiltration (MF) and capacitive deionization.

FIG. 3 shows a variation of a process of partial desalination and softening using a cooling step.

FIG. 4 shows a representative water treatment process.

FIG. 5 shows a representative effect of various polymer viscosities on various brines.

### DETAILED DESCRIPTION

The following description of embodiments provides a non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The present application generally pertains to a process for treating produced water. The process comprises deoiling a produced water to form a substantially deoiled produced water. The deoiled produced water is passed through a microfiltration membrane comprising an ion-exchange functionality under conditions sufficient to produce a water suitable for a steam flooding application. The water suitable for a flooding or other application may comprise a total dissolved solids content of less than about 30,000 ppm and a hardness of less than about 400 ppm.

### Deoiling Produced Water

Generally, produced water may be in need of deoiling depending upon the nature of the produced water, the desired treatment, and the desired use of any treated water. If so, the deoiling may be accomplished in any convenient manner to form a substantially deoiled produced water. Of course, the amount of deoiling may vary depending upon the desired use.

The type of deoiling and equipment employed may vary depending upon the nature and properties of the produced water, the desired properties of any treated water, the equipment available, and/or other factors. Typically, deoiling may comprise induced gas floatation (IGF), employing corrugated plate interceptors (CPI), ultrafiltration, a wellhead screen filter, or any combination thereof.

The specific type of IGF, CPI, ultrafiltration, wellhead screen filter, other deoiling equipment, or desired combination thereof is not particularly critical so long as the desired amount of deoiling is accomplished. Deoiling in IGF and other devices may make use of the high ppm of dissolved gases in the produced water to effectively deoil water. In some embodiments the amount of inlet oil and grease may assist in determining which deoiling method and/or equipment may be employed. For example, if the inlet oil & grease is >300 ppm, a CPI with IGF may be an effective deoiling step.

### Treating Deoiled Water

Further treatments to any produced water, deoiled or otherwise, depend on the nature of produced oil, any deoiling steps and results, and/or desired characteristics of water and/or its ultimate use. In some cases, deoiled water may be treated with a microfiltration membrane comprising an ion-exchange functionality. Of course, the specific membrane or membranes employed, its characteristics, and material of construction may vary depending upon the water to be treated and/or desired characteristics of resultant water. The same may be true of the ion-exchange functionality, if any, that may be employed. Representative microfiltration membranes may be comprised of a polymer or other suitable material. Representative membranes may comprise a polymer such as a polyvinylidene difluoride, a polyacrylonitrile, or a combination thereof. When treating water of higher temperatures a polyvinylidene difluoride may be useful.

The ion-exchange functionality may vary depending on the characteristics of the deoiled water and the desired properties of the water after filtering. Typically, the ion-exchange functionality comprises a sulfonic acid functional group, a carboxylic acid functional group, or a combination thereof. Sulfonic acid groups may be useful in strong acid based applications while carboxylic acid groups may be useful in weak acid based applications.

The microfiltration membrane comprising an ion-exchange functionality may be configured in any useful module. Typical modules may be a porous spiral wound module, a porous hollow fiber module, or even a combination thereof. The ion-exchange functionality may be anchored in the pores of the spongy hydrophilic membrane material. The porous structure facilitates convective transport as opposed to diffusional transport that aids ion-exchange due to better utilization of the ion-exchange sites in the membrane. Commercially available ion-exchange membranes that may be useful in some applications include, for example, supplied by Ionomr, Snowpure, Membrion, Evoqua or ASTOM.

Passing the deoiled produced water through a microfiltration membrane comprising an ion-exchange functionality may be undertaken in any convenient manner. Typically, the filtering is conducted under conditions sufficient to produce a water suitable for a steam flooding application. That is, the microfiltration membrane may be useful in removing residual oil, total suspended solids (TSS), and/or removal of hardness dues to ion exchange. In this manner the produced water may be made more suitable for a flooding, e.g., steam or polymer, or other useful application.

Various ion exchange beads useful herein are commercially available in the form of cation exchangers (sulfonic or carboxyl groups to remove hardness), anion exchangers (strong to weak base amine groups, to remove sulfates, phosphate, etc,), and selective chelating exchangers (iminodiacetate groups, for selective sorption of transition metals, such as, Cu, Ni over hardness metals). Functional groups, located in a typically microporous polymer beads (<10 nm pore pore size), interact with ions that must diffuse from the water outside into the matrix. Because of limited amount of single charged groups (such as, sulfonate) can be attached to interior pore surface, high internal surface areas (>200 m²/g) may be useful to get sufficient metal sorption capacity. Although initial materials may have have calcium ion sorption capacity of 3 to 5 meq/g, high volume regenerants are used to get 50% capacity back for repeated use. In ion exchange columns metal ion sorption is usually by diffusion (little to no convective flow through pores) only portion of the functional groups can be accessed by hardness ions. Thus accessibility of ion exchange sites may be hindered and get further hampered if precipitation of trace iron (as sulfide or hydroxide) takes place in pore mouth or interior surface. On the other hand, if one can use larger pores (50-500 nm) with multiple binding site repeat units from per single chain per unit internal area it will bring additional advantages ranging from convective flow with high accessible capacity. Thus, the present methods may preferably employ pore functionalized microfiltration membranes.

Pore functionalization of microfiltration, MF, membranes through in-situ polymerization or attachment of macromolecules is useful due to pore conformation change and/or creation of relatively high density active sites. Microfiltration usually removes particles only whereas a functionalized MF membrane may capture divalent cations and exclude particles. For example, functionalizing the macropores with polyacrylic acid to create cation exchangers may remove hardness. The extent of functional groups and membrane thickness (volume) often are large factors in determining the ion exchange capacity. Since convective flow can be used, besides high sorption capacity one may also obtain high dynamic capacity utilizing ion exchange groups effectively. The regular positioning of ionic groups on polymer chains in the pores may create an additional metal sorption mechanism due to counterion condensation. As a result, an overall higher metal sorption capacity may be possible.

In some embodiments the produced water may have about 10-50 mg/l Ca. In such cases thee membrane with ion exchange functionality may be regenerated less frequently. Since the polyelectrolytes in the membrane pores may go through conformation change by pH or high salt addition there may be a substantial benefit in regeneration efficiency. Weak acid carboxylic groups are usually easier to regenerate because of conformation change, which is not always possible with sulfonate groups. One skilled in the art with the benefit of the instant specification will readily appreciate useful process adjustments dependent upon such factors as sorption of hardness ions, role of trace iron ions and sulfide, and efficiency of regeneration. While a spiral module design may be useful other module designs besides spiral (350 ft² area, for a 150 micron thick membrane the actual membrane volume occupied is about 2 ft³, this includes spacer) may also be employed.

The characteristics of the water treated in the manner described above may be controlled as desired depending upon the desired application. In some applications produced water may start with from 10,000 to 30,000 ppm of total dissolved solids and/or a hardness of from 2000 to 4000 ppm. In some applications, using the treatment processes described above one may reduce the total dissolved solids and/or the hardness in the produced water by at least 20%, or at least 30%, or at least 40%, or at least 50%, or at least 60%, or at least 70%, or at least 80%, or at least 85%, or at least 90% of the initial total dissolved solids in the produced water. In this manner water treated in the manner described above may comprise a total dissolved solids content of less than about 30,000 ppm, or less than about 25,000 ppm, or less than about 20,000 ppm, or less than about 15,000 ppm, or less than about 10,000 ppm, or less than about 7,000 ppm, or less than about 5,000 ppm, or less than about 4,000 ppm, or less than about 3,000 ppm, or less than about 1,500 ppm, or less than about 1,000 ppm, or less than about 500 ppm. In some embodiments, the treated water may comprise above about 500 ppm, or above about 1000 ppm total dissolved solids content. Similarly, water treated in the manner described above may comprise a hardness of less than about 400 ppm, or less than about 300 ppm, or less than about 200 ppm, or less than about 100 ppm, or less than about 50 ppm. In some embodiments water treated in the manner described above may comprise a hardness above about 100 ppm or above about 200 ppm.

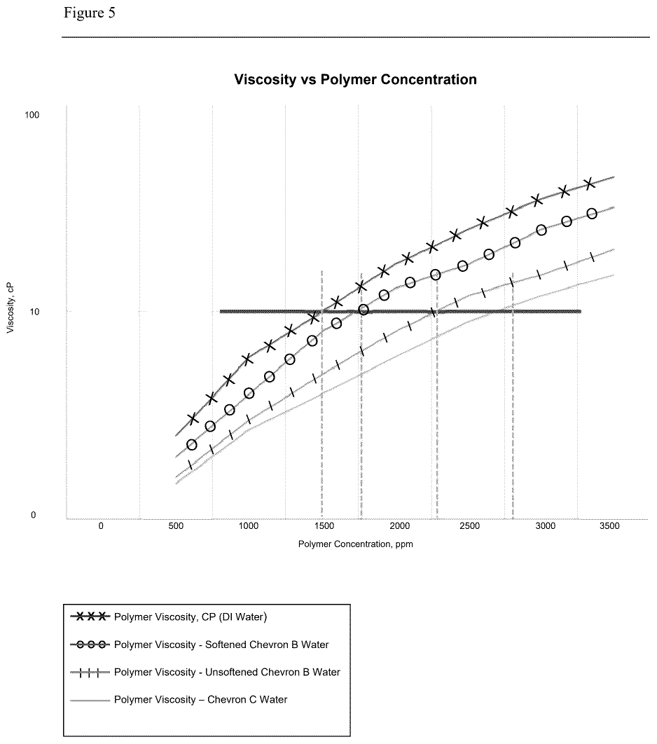

If suitable, the treated water may be used in a steam flooding or a polymer flooding application. As shown in FIG. 5 water treated to reduce salinity or hardness require much less polymer dosage to achieve the target viscosity of 10 centipoise. Of course, if one desires to change additional properties of the water, then further treatment steps may be conducted. For example, the crystallization tendency or potential scaling due to, for example, calcium and/or magnesium, may be reduced in some manner. One convenient manner may be to subject at least a portion up to all of the water in need of treatment to a variable electric field surrounding a pipe or other apparatus holding the water to be further treated. In this manner potential scaling material is kept in suspension instead of adhering to walls of pipe or other equipment.

In some instances, it may be desirable to further treat the water via decarbonating at least a portion of the water to strip carbon dioxide. Additionally, in some embodiments it may be desirable to adjust the pH. The amount of decarbonating and/or pH adjustment will vary depending upon the desired application. In some embodiments the pH of at least a portion of the water treated to be suitable for a steam flooding application is adjusted so that the pH is at least about 7 and less than about 9, or less than about 8. pH adjustment may advantageously facilitate converting at least a portion of H₂S to HS— species. In another embodiment H₂S may be oxidized to sulfate using, for example, electrochlorination.

Depending upon the nature of the desired ultimate application the water may be further treated to reduce residual hardness to less than about 2 ppm.

It may be desirable to condense at least a portion of the water and then reducing the pH of the condensed portion to less than a pH of about 3.

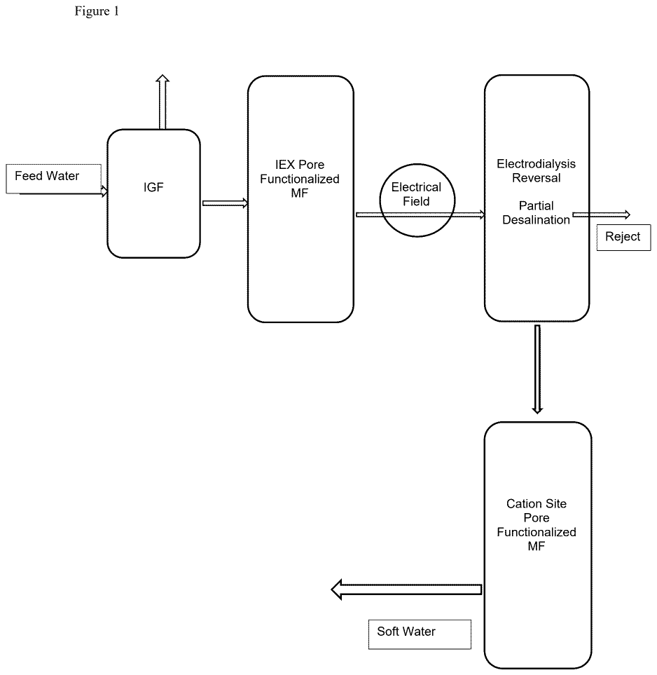

FIG. 1 shows a representative process wherein produced feed water is first deoiled using induced gas floatation (IGF). The water is then subjected to ion-exchange pore functionalized microfiltration (MF). The water is then subjected to an electrical field to reduce scaling while being passed to electrodialysis reversal to partially desalinate the water before cation site pore functionalized microfiltration to reduce the hardness and produce soft water that may be suitable for a flooding application.

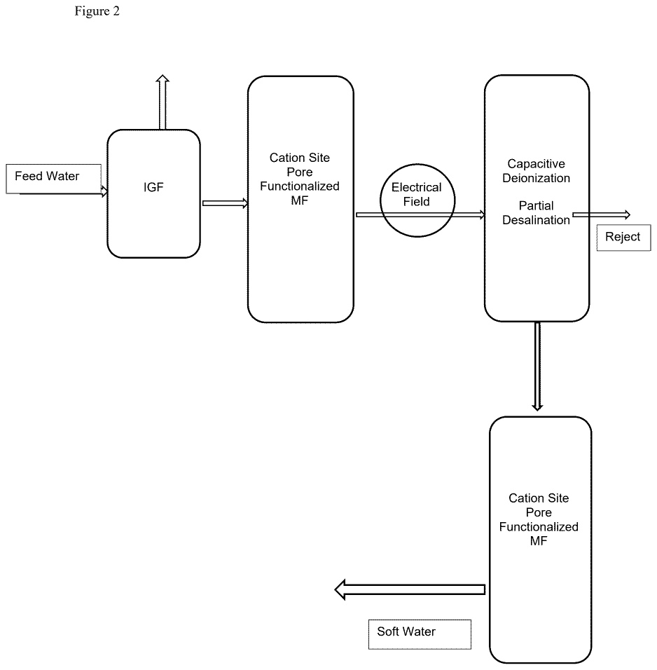

FIG. 2 is alsfpp representative process which begins by deoiling using induced gas floatation (IGF). In FIG. 2 the water is then subjected to cation site pore functionalized microfiltration to reduce the hardness before being subjected to an electrical field to reduce scaling while being passed to capacitive deionization to partially desalinate the water before being treated with cation site pore functionalized microfiltration to produce soft water that may be suitable for a flooding application.

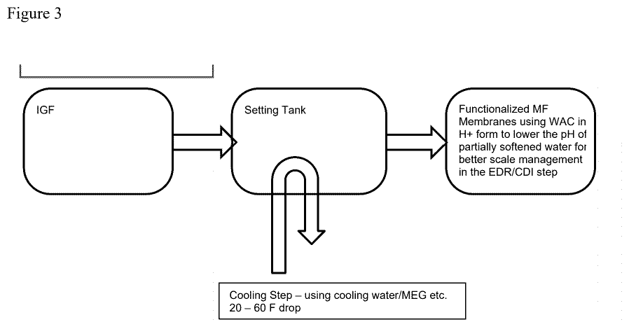

FIG. 3 shows a representative process variation wherein a cooling step is employed after induced gas floatation (IGF) in a settling tank.

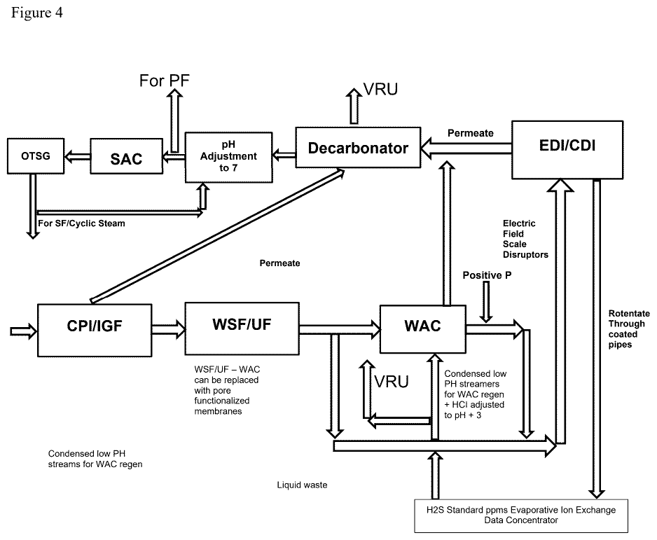

FIG. 4 shows a representative process for treating a produced water for delivery to a once through steam generator (OTSG). In FIG. 4 produced water is deoiled using a CPI/IGF, i.e., induced gas floatation (IGF) and/or corrugated plate interceptors (CPI) before being treated by filtration (with ion-exchange) before being treated with weak acid cation exchange (WAC), electrodialysis or capacitative deionization (EDR/CDI), decarbonated, pH adjusted, and sulfonic acid ion exchange before feeding to the OTSG.

### EXAMPLES

### Example 1

Example 1: Microfiltration with Ion-Exchange Functionallity

| | Inlet | Outlet | |
|---|---|---|---|
| | Conditions | Conditions | Notes |
| Temp, F. | 125-160 | 125-160 | |
| Oil & Grease, ppm | <10 | <0.5 | |
| Turbidity, NTU | 5-10 | <0.5 | |
| Hardness, ppm | 250-10,000 | 200-8000 | Partial Softening |

### Example 2A: Partial Deslination Using Electrodialysis Reversal

Low TDS Water (<2000 ppm): Geochemistry of feed and treated water 2 barrels of produced water (Water A) were treated to 50% & 95% TDS reduction at 140° F.

| | | 50% TDS | | 95% TDS | |
|---|---|---|---|---|---|
| | | Reduction Target | | Reduction Target | |
| Initial | | | % | | % |
| | mg/L | mg/L | Reduction | mg/L | Reduction |
| Dissolved Calcium | 0.314 | 0.503 | −60% | 0.537 | −7% |
| Dissolved | ND | ND | | ND | |
| Magnesium | | | | | |
| Dissolved Potassium | 1.04 | 0.326 | 69% | 0 | 100% |
| Dissolved Iron | 0.153 | 0.174 | −14% | 0.167 | −9% |
| Dissolved | ND | ND | | ND | |
| Manganese | | | | | |
| Dissolved Sodium | 140 | 65.2 | 53% | 7.1 | 95% |
| Chloride | 93.3 | 40.4 | 57% | 3.4 | 96% |
| Sulfate | 9.92 | 2.08 | 79% | 0.333 | 97% |
| Alkalinity, | 195 | 71.9 | 63% | 8.82 | 95% |
| Bicarbonate | | | | | |
| Summations | 439.7 | 180.6 | 59% | 20.4 | 95% |
| Total Dissolved | 480 | 241 | 50% | 152 | 68% |
| Solids, TDS | | | | | |
| Boron | 0.851 | 0.735 | | 0.794 | |
| Barium | ND | ND | | ND | |
| Silica | | 97.6 | | 113 | |
| Strontium | ND | ND | | ND | |

The TDS of Water A was reduced at an energy consumption of 0.039 & 0.025 kW-h/(barrel product water) for 50% & 95% TDS reduction, respectively. Note that some % reduction values are negative due to their low concentration and being near detectable limits and that measured TDS includes dissolved silica.

### Example 2B: Partial Desalination Using EDR

Medium TDS Water (5000-10000 ppm): Geochemistry of feed and treated water. EDR Treated Water (Water B) to 75% & 85% TDS reduction at 150° F.

| | | 75% TDS | | 85% TDS | |
|---|---|---|---|---|---|
| | | Reduction Target | | Reduction Target | |
| Initial | | | % | | % |
| | mg/L | mg/L | Reduction | mg/L | Reduction |
| Dissolved Calcium | 906.3 | 104.5 | 88% | 48.33 | 95% |
| Dissolved | 244.1 | 31.76 | 87% | 13.86 | 94% |
| Magnesium | | | | | |
| Dissolved Potassium | 1.4445 | 1.1 | 24% | 0.3 | 79% |
| Dissolved Iron | 0.23575 | 0.234 | −1% | 0.15 | 36% |
| Dissolved | ND | ND | | ND | |
| Manganese | | | | | |
| Dissolved Sodium | 1862 | 528.1 | 72% | 335.7 | 82% |
| Chloride | 4437 | 1140 | 74% | 720 | 84% |
| Sulfate | 701.3 | 100.5 | 86% | 37.2 | 95% |
| Alkalinity, | 195.2 | 109.8 | 44% | 73.2 | 63% |
| Bicarbonate | | | | | |
| Summations | 8348 | 2016 | 76% | 1229 | 85% |
| Total Dissolved | 8748 | 2184 | 75% | 1399 | 84% |
| Solids, TDS | | | | | |
| Boron | 0.8375% | 1.258 | | 0.794 | |
| Barium | ND | ND | | ND | |
| Silica | 84.75 | 106.9 | | 130.1 | |
| Strontium | 0.55 | ND | | ND | |

Conclusion: EDR was able to successfully reduce the TDS of Water B at 150° F. at an energy consumption of 0.051 W-h/(barrel product water)/(Δppm).

### Example 2C

Example 2C: Partial Desalination Using EDR
High TDS Water (20,000-30,000 ppm):
Geochemistry of feed and teated water

| | In | Out |
|---|---|---|
| Na++, ppm | 8100 | 2025 |
| Mg++, ppm | 650 | 163 |
| Ca++, ppm | 2350 | 588 |
| HCO3−, ppm | 1350 | 122 |
| Cl−, ppm | 15500 | 4241 |
| SO4 2−, ppm | 2000 | 500 |
| SiO2, ppm | 11 | 9.6 |
| Key Information | | |
| Recovery | 40%-50% | |
| TDS Reduction Range | 65%-85% | |
| Inlet Water TDS Range, ppm: | 20000-30000 | |
| Outlet Water TDS Range, ppm | 3000-8000 | |
| Inlet Hardness, ppm | 6000-9000 | |
| Oulet Hardness, ppm | 900-2400 | |
| Temperature, F. | 140-170 | |
| Energy Consumption | 1.5-3.0 kWh/bbl | |

### Example 3A

Example 3A: Partial Destination Using Capacitive Deionization
Low TDS Water (<3500 uS/cm conductivity):
Geochemistry of feed and teated water

| | | | Conductivity |
|---|---|---|---|
| | | | Reduction |
| Criterion | Feed | Permeate | (%) |
| Case 1: Conductivity | 838 | 370 | 56 |
| (uS/cm) | | | |
| Case 2: Conductivity | 838 | 75 | 90 |
| (uS/cm) | | | |
| Key Information | | | |
| Recovery | 80%-90% | | |
| TDS Reduction | 80%-95% | In the two cases above, | |
| Range | | it is 56% and 90% | |
| Inlet Water TDS | 400-2000 | | |
| Range, ppm: | | | |
| Temperature, F. | 125-160 | | |
| Energy Consumption | 0.03-0.3 kwH/bbl | | |

### Example 3B

Example 3B: Partial Destination Using EDR
Low TDS Water (<3500 uS/cm conductivity):
Geochemistry of feed and teated water

| | | | TDS |
|---|---|---|---|
| Criterion | Feed | Permeate | Reduction, % |
| Case 1 | | | |
| TDS, mg/L | 440 | 180 | 59 |
| Case 2 | | | |
| TDS, mg/L | 440 | 21 | 95 |

Note: This data supports 2A data above

Example 3B: Partial Destination Using EDR
Medium TDS Water (<3500 uS/cm conductivity):
Geochemistry of feed and teated water

| | | | TDS/Hardness |
|---|---|---|---|
| Criterion | Feed | Permeate | Reduction, % |
| Case 1 | | | |
| Conductivity | 13590 | 1920 | 86 |
| TDS, mg/L | 8348 | 1229 | 85 |
| Ca++, mg/L | 906 | 48 | 95 |
| Ma++, mg/L | 244 | 14 | 94 |
| Hardness, mg/L | 3280 | 178 | 95 |
| Case 2 | | | |
| Conductivity | 13590 | 3149 | 77 |
| TDS, mg/L | 8348 | 2016 | 76 |
| Ca++, mg/L | 906 | 104 | 88 |
| Mg++, mg/L | 244 | 32 | 87 |

Note: This data supports 2B data above

### Example 4A

Example 4A: IEX Softening to less than 2 ppm hardness
Low TDS Waters

| | Inlet | Outlet |
|---|---|---|
| TDS, ppm | 400-2000 | 400-2000 |
| Hardness | 2.5-50 | <2 |
| Regenerant | 10-18% brine | |
| Softening System | SAC-SAC (functionalized MF with sulfonic group) | |
| Product Recovery % | ~98% | |

### Example 4B

Example 4B: IEX Softening to less than 2 ppm hardness
Medium TDS Waters

| | Inlet | Outlet |
|---|---|---|
| TDS, ppm | 5000-10000 | 5000-10000 |
| Hardness | 150-1000 | <2 |
| Regenerant | 10-18% brine | |
| Softening System | SAC-SAC (functionalized MF with sulfonic group) | |
| Product Recovery % | ~95% | |

### Example 4C

Example 4C: IEX Softening to less than 2 ppm hardness
High TDS Waters

| | Inlet | Outlet |
|---|---|---|
| TDS, ppm | 3000-8000 | 50-500 |
| Hardness | 900-2400 | <2 |

| | |
|---|---|
| Regenerant | 4-6% HCl and 4-6% NaOH |
| Softening System | WAC-WAC (functionalized MF |
| | with carboxylic group) |

| | |
|---|---|
| Product Recovery % | ~90% |

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

We claim:

1. A process for treating produced water comprising:
deoiling a produced water to form a substantially deoiled produced water; and
passing the deoiled produced water through a microfiltration membrane comprising an ion-exchange functionality under conditions sufficient to produce a water suitable for a steam flooding application;
wherein water suitable for a flooding application comprises a total dissolved solids content of less than about 30,000 ppm and a hardness of less than about 400 ppm.

2. The process of claim 1 wherein the flooding application is selected from a steam flooding application or a polymer flooding application.

3. The process of claim 1 wherein the water suitable for a flooding application comprises a total dissolved solids content of less than about 7,000 ppm.

4. The process of claim 1 wherein the water suitable for a flooding application comprises a total dissolved solids content of less than about 7,000 ppm and a hardness of less than about 200 ppm.

5. The process of claim 1 wherein the deoiling comprises induced gas floatation.

6. The process of claim 1 wherein the deoiling comprises employing corrugated plate interceptors.

7. The process of claim 1 wherein the deoiling comprises ultrafiltration.

8. The process of claim 1 wherein the deoiling comprises a combination of employing corrugated plate interceptors and induced gas floatation.

9. The process of claim 1 wherein the deoiling comprises employing a wellhead screen filter.

10. The process of claim 1 wherein the microfiltration membrane comprising an ion-exchange functionality comprises a membrane comprising a polyvinylidene difluoride, a polyacrylonitrile, or a combination thereof.

11. The process of claim 1 wherein the microfiltration membrane comprising an ion-exchange functionality comprises a sulfonic acid functional group, a carboxylic acid functional group, or a combination thereof.

12. The process of claim 1 wherein the microfiltration membrane comprising an ion-exchange functionality is a porous spiral wound module or a porous hollow fiber module.

13. The process of claim 1 which further comprises reducing crystallization tendency of the water suitable for a steam flooding application.

14. The process of claim 13 wherein the crystallization tendency is reduced by subjecting at least a portion of the water suitable for a steam flooding application to a variable electric field.

15. The process of claim 1 which further comprises decarbonating at least a portion of the water suitable for a steam flooding application.

16. The process of claim 1 which further comprises adjusting the pH of at least a portion of the water suitable for a steam flooding application to between from about 7 to about 8.

17. The process of claim 1 which further comprises adjusting the residual hardness of at least a portion of the water suitable for a steam flooding application to less than about 2 ppm.

18. The process of claim 1 which further comprises condensing at least a portion of the water suitable for a steam flooding application and then reducing the pH of the condensed portion to less than a pH of about 3.

19. A process for treating produced water comprising:
deoiling a produced water to form a substantially deoiled produced water;
passing the deoiled produced water through a microfiltration membrane comprising an ion-exchange functionality under conditions sufficient to produce a water suitable for a steam flooding application;
wherein water suitable for a flooding application comprises a total dissolved solids content of less than about 30,000 ppm and a hardness of less than about 400 ppm;
wherein the deoiling comprises a combination of employing corrugated plate interceptors and induced gas floatation; and
wherein the microfiltration membrane comprises an ion-exchange functionality comprises a membrane comprising a polyvinylidene difluoride, a polyacrylonitrile, or a combination thereof with an ion-exchange functionality comprising a sulfonic acid functional group, a carboxylic acid functional group, or a combination thereof.

20. The process of claim 19 wherein the microfiltration membrane comprising an ion-exchange functionality is a porous spiral wound module or a porous hollow fiber module and wherein the water suitable for a flooding application comprises a total dissolved solids content of less than about 7,000 ppm and a hardness of less than about 200 ppm.
